(19) United States
(12) Patent Application Publication
(10) Pub. No.: US 2009/0115734 A1
(43) Pub. Date: May 7, 2009

(54) PERCEIVABLE FEEDBACK

(75) Inventors: Anders FREDRIKSSON, Enskede (SE); Gunnar KLINGHULT, Lund (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/952,493

(22) Filed: Dec. 7, 2007

Related U.S. Application Data
(60) Provisional application No. 60/984,854, filed on Nov. 2, 2007.

(51) Int. Cl. G06F 3/041

(52) U.S. Cl. 345/173

(57) ABSTRACT

The present invention is directed to a portable device and a method for using such a device, which device includes a touch sensitive arrangement comprising: a touch-surface arranged to be operatively actuated and to operatively receive touches from a user of the device, an actuator arrangement arranged to operatively actuate at least a part of the touch-surface, a control arrangement arranged to operatively detect touches on the touch-surface and to operatively control the actuator to actuate the touch-surface so as to provide a perceivable feedback to the user as a response to a detected touch. The actuator arrangement may include an electroactive polymer arrangement arranged to be operatively actuated by the control arrangement so as to actuate the touch-surface for providing a perceivable feedback to the user as a response to a detected touch.

### CROSS REFERENCE TO RELATED APPLICATION

The instant application claims priority from provisional application No. 60/984,854, filed Nov. 2, 2007, the disclosure of which is incorporated by reference herein in its entirety.

### TECHNICAL FIELD OF THE INVENTION

The present invention relates to devices provided with touch sensitive arrangements such as a touchscreen or similar. In particular, the present invention relates to an arrangement and a method for providing a tactile or at least a perceivable feedback to users of such devices.

### DESCRIPTION OF RELATED ART

As is well known to those skilled in the art such items as buttons, track balls and/or thumbwheels or similar are commonly provided as an interface between a device and a user of the device—i.e. provided as the user interface or the so-called Man-Machine Interface (MMI). It is also well known that touchscreens are frequently preferred as a user interface in small devices, e.g. in portable communication devices such as cell phones and in other portable devices such as personal digital assistants (PDA) and similar. This is i.e. due to the fact that touch sensitive arrangements such as touchscreens or similar do usually not involve the intricate assemblies and the operational space etc required for implementing mechanical user interfaces such as buttons, track balls and thumb wheels or similar.

However, although touchscreens have been commonly used in portable devices they do not offer the tactility provided by typical mechanical user interfaces, e.g. provided by those exemplified above. Mechanical interfaces are typically able to provide the user with a feeling that an input has been made, e.g. due to the natural movement of a button or a thumbwheel or similar. Touchscreen systems, on the other hand, are typically limited to provide a visual and/or audible feedback of a successful input to the user. This is often insufficient. For example, a visual-only feedback may substantially increase the possibility of input error resulting in a decreased efficiency of use, whereas audio notification works poorly in noisy environments and may disturb the user or other people who are close by.

To overcome at least some drawbacks associated with typical touchscreens further developments have provided touchscreens with a tactile feedback. An example of a touchscreen with tactile feedback is discloses in the patent U.S. Pat. No. 5,977,867 (Blouin) published in Nov. 2, 1999. Blouin discloses a touchscreen provided with a mechanical vibrator for producing a tactile feedback to the user when the touchscreen is touched with a finger. Blouin suggests a motor as the mechanical vibrator.

However, mechanical vibrators in the form of motors and the like are typically occupying a non-negligible space in a portable device. Moreover, known mechanical vibrators suffer from high power consumption. In addition, mechanical vibrators are static in that they are typically limited to a single tactile response. In addition, known mechanical vibrators or similar comprises parts that are difficult to produce and/or to assemble. Similarly, typical mechanical vibrators or similar requires a fairly complex mounting and/or connecting procedure. In addition, known mechanical vibrators and the like are typically susceptible to shock, i.e. they are not shockproof.

Hence, it would be advantageous to have an improved portable device and an improved method for providing a feedback to a user as a response to a touch on a touch sensitive arrangement, whereby at least one of the disadvantages identified above can be mitigated or overcome.

### SUMMARY OF THE INVENTION

The present invention is directed to solving the problem of providing an improved portable device and an improved method for providing a feedback to a user as a response to a touch on a touch sensitive arrangement, whereby at least one of the disadvantages identified above can be mitigated or overcome. Particular aspects of the present invention are intended to solve at least one of the problems of providing a small, low-power, flexible, simple, substantially shockproof actuator for providing a feedback to a user as a response to a touch on a touch sensitive arrangement.

At least one of the problems identified above is solved according to a first embodiment of the invention directed to a portable device comprising a touch sensitive arrangement comprising a touch-surface arranged to be operatively actuated and to operatively receive touches from a user of the device an actuator arrangement arranged to operatively actuate at least a part of said touch-surface, a control arrangement arranged to operatively detect touches on said touch-surface and to operatively control said actuator to actuate said touch-surface so as to provide a perceivable feedback to the user as a response to a detected touch.

In particular, said actuator arrangement comprises an electroactive polymer arrangement arranged to be operatively actuated by said control arrangement so as to actuate said touch-surface for providing a perceivable feedback to the user as a response to a detected touch.

A second embodiment of the invention is directed to a portable device including the features of the first embodiment, and wherein said electroactive polymer arrangement comprises at least one region of an electroactive polymer, and at least a first electrode arrangement and at least a second electrode arrangement that are arranged to operatively actuate said region of said electroactive polymer and to be operatively controlled by said control arrangement.

A third embodiment of the invention is directed to a portable device including the features of the first or the second embodiment, and wherein said actuator arrangement is attached to said touch-surface for operatively actuating the touch surface so as to provide a perceivable feedback to the user.

A fourth embodiment of the invention is directed to a portable device including the features of the third embodiment, and wherein said actuator arrangement is attached to a rear surface of said touch-surface or to a side of said touch-surface, so as to be able to operatively actuate the touch surface.

A fifth embodiment of the invention is directed to a portable device including the features of the first or second embodiment, and wherein said electroactive polymer arrangement comprises at least one region of an electroactive polymer that is formed by said touch-surface.

A sixth embodiment of the invention is directed to a portable device including the features of the fifth embodiment, and wherein substantially the entire touch-surface is formed by an electroactive polymer.

A seventh embodiment of the invention is directed to a portable device including the features of the first, second, third, fourth, fifth or sixth embodiment, and wherein said actuator arrangement and said touch-surface and said control arrangement are arranged so as to operatively provide a tactile feedback or an audible feedback to the user as a response to an event detected by the control arrangement.

An eighth embodiment of the invention is directed to a portable device including the features of the seventh embodiment, and wherein said audible feedback comprises voice signal and/or a music signal to the user as a response to an event detected by the control arrangement.

At least one of the problems identified above is also solved according to a ninth embodiment of the invention directed to a method for providing a feedback in a portable device, which device comprises a touch sensitive arrangement comprising; a touch-surface arranged to be operatively actuated and to operatively receive touches from a user of the device, an actuator arrangement arranged to operatively actuate at least a part of said touch-surface, a control arrangement arranged to operatively detect a touch on said touch-surface and to operatively control the actuator to actuate said touch-surface so as to provide a perceivable feedback to the user as a response to a detected touch, wherein said actuator arrangement comprises an electroactive polymer arrangement arranged to be operatively actuated by said control arrangement so as to actuate said touch-surface for providing a perceivable feedback to the user as a response to a detected touch.

In particular, the method comprises the steps of:

detecting a touch on the touch-surface,

actuating the electroactive polymer arrangement comprised by the actuator arrangement so as to provide a perceivable feedback from the touch-surface to the user as a response to a detected touch.

A tenth embodiment of the invention is directed to a method including the features of the ninth embodiment, wherein said electroactive polymer arrangement comprises at least one region of an electroactive polymer, and at least a first electrode arrangement and at least a second electrode arrangement that are arranged to operatively actuate said region of said electroactive polymer and to be operatively controlled by said control arrangement. The method comprises the steps of actuating said first electrode arrangement and said second electrode arrangement of said region so as to provide a perceivable feedback from the touch-surface to the user as a response to a detected touch.

An eleventh embodiment of the invention is directed to a method including the features of the ninth embodiment, wherein said electroactive polymer arrangement comprises at least one region of an electroactive polymer that is formed by said touch-surface. The method comprises the steps of actuating said region so as to provide a perceivable feedback from the touch-surface to the user as a response to a detected touch.

A twelfth embodiment of the invention is directed to a method including the features of the ninth embodiment, and wherein substantially the entire touch-surface surface is formed by an electroactive polymer. The method comprises the steps of: actuating said touch-surface so as to provide a perceivable feedback from the touch-surface to the user as a response to a detected touch.

A thirteenth embodiment of the invention is directed to a method including the features of the ninth, tenth, eleventh or twelfth embodiment, which method comprises the steps of: actuating the actuator arrangement and said touch-surface so as to operatively provide a tactile feedback or an audible feedback to the user as a response to an event detected by the control arrangement.

A fourteenth embodiment of the invention is directed to a method including the features of the ninth, tenth, eleventh, twelfth or thirteenth embodiment, which method comprises the steps of: actuating the actuator arrangement and said touch-surface so as to provide a voice signal and/or a music signal to the user as a response to an event detected by the control arrangement.

A fifteenth embodiment of the invention is directed to a computer program product stored on a computer usable medium, comprising readable program means for causing a portable device to execute, when said program means is loaded in the portable device, comprising a touch-surface arranged to be operatively actuated and to operatively receive touches from a user of the device, an actuator arrangement arranged to operatively actuate at least a part of said touch-surface, a control arrangement arranged to operatively detect a touch on said touch-surface and to operatively control the actuator to actuate said touch-surface so as to provide a perceivable feedback to the user as a response to a detected touch, wherein said actuator arrangement comprises an electroactive polymer arrangement arranged to be operatively actuated by said control arrangement so as to actuate said touch-surface surface for providing a perceivable feedback to the user as a response to a detected touch, the steps of: detecting a touch on the touch-surface, actuating the electroactive polymer arrangement comprised by the actuator arrangement so as to provide a perceivable feedback from the touch-surface to the user as a response to a detected touch.

A sixteenth embodiment of the invention is directed to a computer program element having program recorded thereon, where the program is to make a portable device to execute, when said program means is loaded in the portable device, comprising, a touch-surface arranged to be operatively actuated and to operatively receive touches from a user of the device, an actuator arrangement arranged to operatively actuate at least a part of said touch-surface, a control arrangement arranged to operatively detect a touch on said touch-surface and to operatively control the actuator to actuate said touch-surface so as to provide a perceivable feedback to the user as a response to a detected touch, wherein said actuator arrangement comprises an electroactive polymer arrangement arranged to be operatively actuated by said control arrangement so as to actuate said touch-surface for providing a perceivable feedback to the user as a response to a detected touch, the steps of: detecting a touch on the touch-surface, actuating the electroactive polymer arrangement comprised by the actuator arrangement so as to provide a perceivable feedback from the touch-surface to the user as a response to a detected touch.

Further advantages of the present invention and embodiments thereof will appear from the following detailed description of the invention.

It should be emphasized that the term “comprises/comprising” when used in this specification is taken to specify the presence of stated features, integers, steps or components, but does not preclude the presence or addition of one or more other features, integers, steps, components or groups thereof.

It should also be emphasized that the methods defined in the appended claims may, without departing from the present invention, be performed in another order than the order in which they appear in the claims.

### BRIEF DESCRIPTION OF THE DRAWINGS

The present invention will now be described in more detail in relation to the enclosed 5 drawings, in which:

FIG. 1 shows a portable device in the form of a schematic cell phone 10.

FIG. 2 shows a schematic diagram of the relevant parts of the cell phone 10 in FIG. 1.

FIG. 3a shows the cell phone 10 in FIG. 1 provided with a first schematic exemplifying tactile touchscreen 20a having a first exemplifying electroactive touch-surface 22a.

FIG. 3b shows a section of the cell phone 10 and the first tactile touchscreen 20a, seen in the direction indicated by the arrows A-A in FIG. 3a.

FIG. 3c shows the actuator 30a in FIG. 3b in an exemplifying contracted state.

FIG. 4 shows a section of the cell phone 10 provided with a second schematic and exemplifying tactile touchscreen 20b, seen in the direction indicated by the arrows A-A in FIG. 3a.

FIG. 5 shows a section of the cell phone 10 provided with a third schematic and exemplifying tactile touchscreen 20c, seen in the direction indicated by the arrows A-A in FIG. 3a.

FIG. 6a shows the cell phone 10 in FIG. 1 provided with a second schematic exemplifying touch-surface 22b made of an electroactive polymer.

FIG. 6b shows a section of the cell phone 10 and the second touch-surface 22b, seen in the direction indicated by the arrows A-A in FIG. 6a.

FIG. 7 shows a flowchart of an exemplifying operation of a tactile touchscreen according to an embodiment of the present invention.

FIG. 8 shows a CD ROM on which program code for executing the method according to the invention is provided.

### DETAILED DESCRIPTION OF EMBODIMENTS

The present invention relates to portable devices comprising a touch sensitive arrangement. In particular, the invention relates to portable communication devices comprising a touchscreen or similar touch sensitive arrangement. However, the invention is by no means limited to communication devices or touchscreens. Rather, it can be applied to any suitable portable device comprising a suitable touch sensitive arrangement.

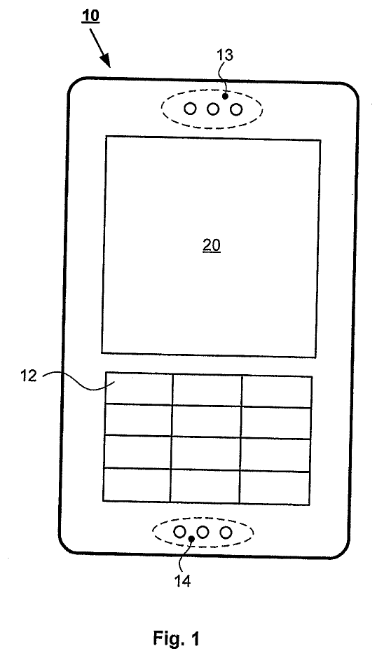

FIG. 1 shows an exemplifying portable communication device according to a preferred embodiment of the invention. Preferably, the device is a mobile cell phone 10. However, as indicated above, the cell phone 10 in FIG. 1 is just one example of a portable device in which the invention can be implemented. The invention can for instance be implemented in a PDA (personal digital assistant), a palm top computer, a lap top computer or a smartphone or any other suitable portable device.

The cell phone 10 in FIG. 1 comprises a keypad 12, a loudspeaker 13 and a microphone 14. The keypad 12 is used for entering information such as selection of functions and responding to prompts. The keypad 12 may be of any suitable kind, including but not limited to keypads with suitable push-buttons or similar and/or a combination of different 15 suitable button arrangements. The loudspeaker 13 is used for presenting sounds to a user and the microphone 14 is used for sensing the voice from the user or similar. In addition, the cell phone 10 includes an antenna, which is used for communication with other users via a network. The antenna is in-built in the cell phone 10 and hence not shown in FIG. 1.

Moreover, the cell phone 10 in FIG. 1 comprises a tactile touch sensitive arrangement comprising an exemplifying tactile touchscreen 20. The tactile touchscreen 20 comprises a touch function arranged to operatively receive and/or sense touches made by a user on the front surface of the touchscreen 20 facing the user. It is also preferred that the tactile touchscreen 20 comprises a display function arranged to operatively present such items as functions, prompts, still and/or moving images etc to a user. A touch function and a display function are almost mandatory features of typical touchscreens and they are also well known to those skilled in the art. Exemplifying touch screens in this category can e.g., be found in modern cell phones such as the M600i, W950i, P990i and others from Sony Ericsson. Hence, the well known touch function and display function of a touchscreen need no detailed description.

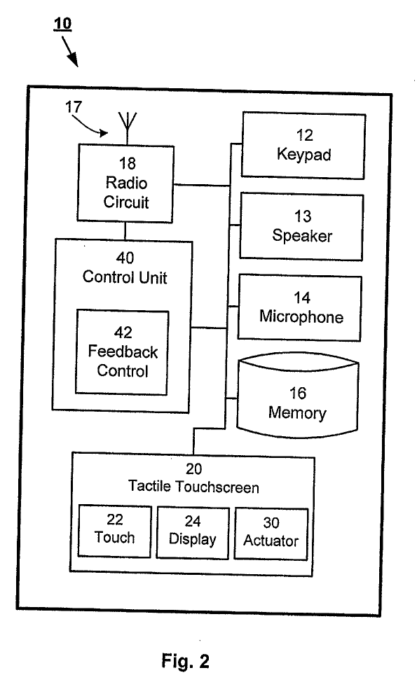

FIG. 2 shows parts of the interior of the cell phone 10 being relevant for the present invention. As previously explained, it is preferred that the cell phone 10 comprises a keypad 12, a speaker 13, a microphone 14 and a tactile touchscreen 20.

In particular, it is preferred that the tactile touchscreen 20 comprises a touch-surface 22 for receiving and/or detecting touches from a user of the cell phone 10, a display function 24 for presenting functions, prompts, still images and/or moving images etc as mentioned above, and an actuator function 30 for providing a tactile feedback to a user as a 5 response to a touch on the touch-surface 22 of the touchscreen 20.

As will be explained later, a first embodiment 20a of the touchscreen 20 may comprise a first embodiment 30a of the actuator 30, a second embodiment 20b of the touchscreen 20 may comprise a second embodiment 30b of the actuator 30, a third embodiment 20c of the touchscreen 20 may comprise a third embodiment 30c of the actuator 30 and a fourth embodiment 20d of the touchscreen 20 may comprise a fourth embodiment 30d of the actuator 30. The first, second and third embodiments of the touchscreen 20 may comprise a first embodiment 22a of the touch-surface 22, whereas the fourth embodiment 20d of the touchscreen 20 may comprise a second embodiment 22b of the touch-surface 22.

In addition, the cell phone 10 is preferably provided with a memory arrangement 16 for storing such items as e.g. system files and data files etc. The memory arrangement 16 may be any suitable memory or combination of memories that are commonly used in known portable devices such as e.g. cell phones or similar. In addition, the cell phone 10 comprises an antenna 17 connected to a radio circuit 18 for enabling wireless communication with a cellular network.

Furthermore, the cell phone 10 is provided with a control unit 40 for controlling and supervising the operation of the cell phone 10. The control unit 40 may be implemented by means of hardware and/or software, and it may comprise one or several hardware units and/or software modules, e.g. one or several separate processor arrangements provided with or having access to the appropriate software and hardware required for the functions to be performed by the cell phone 10, as is well known by those skilled in the art. As can be seen in FIG. 2, it is preferred that the control unit 40 is connected to or at 30 least arranged to operatively communicate with the keypad 12, the speaker 13, the microphone 14, the tactile touchscreen 20, the radio unit 18 and the memory 16. This provides the control unit 40 with the ability to control and communicate with these units to e.g., exchanging information and instructions with the units.

In particular, the control unit 40 is provided with a feedback-control 42, which is of special interest in connection with the present invention. Being a part of the control unit 40 implies that the feedback-control 42 can be implemented by means of hardware and/or software and it can comprise one or several hardware units and/or software modules, e.g., one or 5 several separate processor units provided with or having access to the software and hardware appropriate for the functions required. The feedback-control 42 is arranged to operatively control the tactile touchscreen arrangement 20 so as to comprise and/or communicate with the touch function of the touchscreen arrangement 20 for sensing touches made by a user on a touch-surface 22a of the touchscreen 20, and so as to activate the actuator function 30 as a response to a sensed touch as will be described in more detail below.

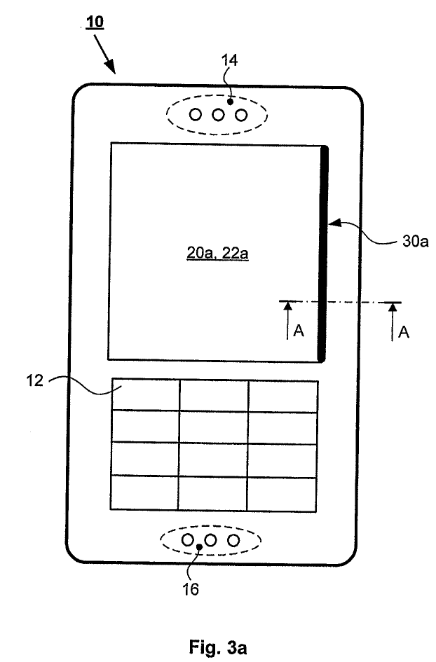

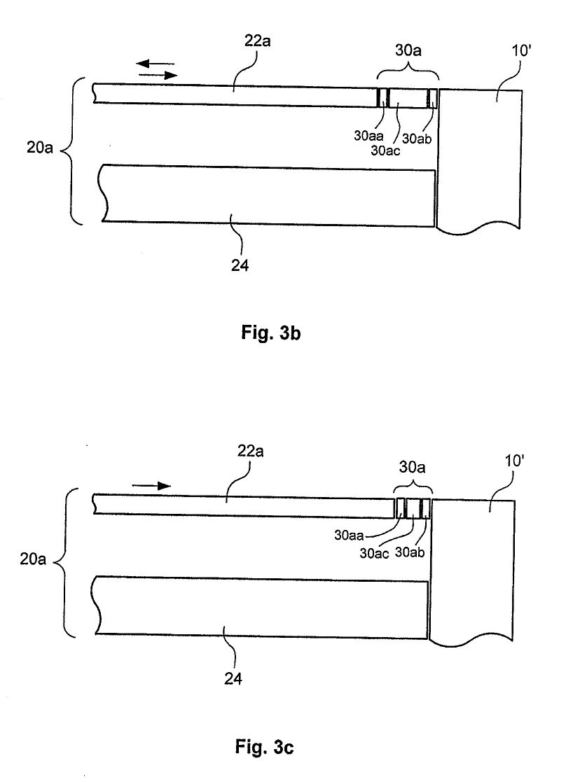

FIG. 3a shows the cell phone in FIG. 1 provided with a first exemplifying tactile touchscreen 20a comprising an exemplifying actuator 30a illustrated by a fat line extending along the right side of the substantially rectangular or quadratic tactile touchscreen 20a.

Before we proceed, it should be added that the actuator 30a may be provided on other sides or similar of the tactile touchscreen 20a. For example, one or several actuators such as the actuator 30a or similar may be provided at the right, left, upper and/or lower side or similar of a tactile touchscreen such as the tactile touchscreen 20a. Moreover, an actuator must not extend throughout the whole length of a side of the tactile touchscreen. An actuator such as the actuator 30a or similar may e.g. only extend along a part of a side or similar of a tactile touchscreen such as the tactile touchscreen 20a or similar, e.g. extend along a part that is less than half, or less than a third, or less than a fourth, or less than a fifth, or less than a sixth, or less than a seventh, or less than an eight, or less than a ninth or less than a tenth of the side in question. In addition, an actuator such as the actuator 30a or similar may extend from a position at or near an end of a tactile touchscreen such as the tactile touchscreen 20a or similar, or from a position at or near the middle of a side or similar of the touchscreen. The actuator may e.g. extend in either direction from the middle of a side, or in both directions from the middle of a side, e.g. substantially symmetrically from the middle of a side.

FIG. 3b shows a section of the cell phone 10 and the exemplifying tactile touchscreen 20a seen in the direction indicated by the arrows A-A in FIG. 3a. As can be seen in FIG. 3b the tactile touchscreen 20a comprises a display function 24 that may be implemented by means of an LCD or some other suitable display that is arranged to operatively display such items as e.g. functions, prompts, still and/or moving images etc. to a user as is well known to those skilled in the art.

In addition, the tactile touchscreen 20a has a touch sensing function comprising a touch-surface 22a arranged above the display 24 and arranged so as to operatively receive and/or detect touches from a user of the cell phone 10. The touch sensing function may e.g. be implemented by means of a resistive, capacitive, surface-wave-acoustic (SAW) or infrared technique or some other suitable touch sensing technique as is well known to those skilled in the art.

It is well known in the art that the resistive touch sensing techniques utilize a substantially resilient and/or elastic and laminar touch sensing layer that is arranged to operatively produce a detectable position signal when it is touched. Hence, in case of a resistive technique it is preferred that the touch-surface 22a is or corresponds to the laminar touch sensing layer and that the tactile control 42 comprises such hardware and software that is well known to those skilled in the art as being suitable for detecting the position signals generated by means of said touch-surface 22a as a response to a touch. Alternatively, the touch-surface 22a may correspond to a separate substantially resilient layer arranged on top of the actual laminar touch sensing layer.

It is also well known in the art that capacitive touch sensing techniques utilizes an electrically conductive touch sensing plate or similar that is arranged to operatively produce a detectable position signal when it is touched. The plate may e.g., be a glass plate or similar provided with a thin substantially transparent and electrically conductive surface layer (e.g. a thin layer of metal oxide). Hence, in case of a capacitive technique it is preferred that the touch-surface 22a is or corresponds to the touch sensing plate or similar and that the tactile control 42 comprises such hardware and software that is well known to those skilled in the art as being suitable for detecting the position signals generated by means of said touch-surface 22a as a response to a touch.

It is also well known in the art that SAW touch sensing techniques utilizes a touch sensing plate or similar that can propagate sound waves or similar. The touch sensing plate may e.g., be implemented by means of a glass plate or similar. Hence, in case of a SAW technique it is preferred that the touch-surface 22a is or corresponds to the touch sensing plate or similar and that the tactile control 42 comprises such hardware and software that is well known to those skilled in the art as being suitable for detecting the position signals generated by means of said touch-surface 22a as a response to a touch.

It is also well known that infrared touch sensing techniques or similar are typically implemented by means of light that is emitted across and in parallel to a touch sensing surface and received by sensors that senses a touch by detecting an interruption of the emitted light. Here the composition of the touch sensing surface is less important and the touch-surface 22a may therefore be implemented as a flat plate or similar without any particular restriction on its composition. Hence, in case of an infrared technique or similar it is preferred that the touch-surface 22a is or corresponds to the touch sensing surface and that the tactile control 42 comprises such hardware and software that is well known to those skilled in the art as being suitable for generating position signals by means of emitted and received light as a response to a touch.

It should be added that it is generally preferred that the touch-surface 22a is transparent or at least substantially transparent so that the display 24 or similar display function arranged beneath the touch-surface 22a can be seen through the touch-surface 22a.

The display function and the touch sensing function of the tactile touchscreen 20a have been discussed above with reference to the touch-surface 22a and the display 24 respectively. The attention is now directed to the exemplifying actuator 30a as shown in FIGS. 3a and 3b.

The actuator 30a is illustrated in FIG. 3a. The actuator 30a is also illustrated in FIG. 3b shown in a section of the cell phone 10 seen in the direction indicated by the arrows A-A in FIG. 3a. It is preferred that the actuator 30a is attached to a side of the touch-surface 22a as described above and to the body 10′ or similar of the cell phone 10. It is also preferred that the touch-surface 22a is arranged so that it can be actuated by the actuator 30a as will be explained below, e.g. so that it can be moved or oscillated or similar by the actuator 30a. e.g. moved and/or oscillated back and forth as indicate by the two opposite arrows.

It is preferred that the actuator 30a is implemented by means of an electroactive polymer arrangement indicated by 30aa, 30ab and 30ac in FIG. 3b. Electroactive polymers are well known per se, see e.g. the patent document WO 2007/029275 (Carpi et al.) published in Mar. 15, 2007. Using an electroactive polymer arrangement 30aa, 30ab, 30ac provides a substantially shockproof and highly flexible actuator 30a with high compliance, low density, low power consumption, simple manufacturing and low cost.

The exemplifying actuator 30a in FIG. 3b comprises a region of an electroactive polymer 30ac and a first electrically conductive electrode arrangement 30aa and a second electrically conductive electrode arrangement 30ab. As can be seen in FIG. 3b It is preferred that the electrodes 30aa, 30ab are arranged on substantially opposite sides of the intermediate region of the electroactive polymer 30ac. Moreover, it is preferred that the electrodes 30aa, 30ab are connected to or at least controlled by the tactile control 42 of the cell phone 10 and that the tactile control 42 is arranged to operatively apply a voltage or similar to the electrodes 30aa, 30ab as a response to a touch on the touch-surface 22a. In this manner the electroactive polymer 30ac can be actuated by applying a voltage across the polymer 30ac by means of the electrodes 30aa, 30ab as a response to a touch on the touch-surface 22a, e.g. deformed repeatedly as will be described in more detail below.

The electrodes 30aa, 30ab may e.g. be made of an electrically conductive metal foil or an electrically conductive metal sheet or similar, or of an electrically conductive polymer or elastomer or similar e.g. loaded or doped with conductive particles or similar.

The position of the electrodes 30aa, 30ab shown in FIG. 3b is merely an example. Naturally there are other positions in which the electrodes 30aa, 30ab can be arranged to operatively affect the electroactive polymer 30ac. For example, one or both electrodes 30aa or 30ab may e.g. be arranged substantially in parallel to the electroactive polymer 30ac extending between the touch-surface 22a and the body 10′ or similar. Moreover, at least a part of one or both electrodes 30aa, 30ab may be implemented by means of the touch-surface 22a and/or by means of the body 10′ or similar of the cell phone 10 to which the actuator 30a is attached. This may e.g., be the case if the touch-surface 22a is at least partly made of an electrically conductive material, which may be the case when a capacitive touch sensing technique is used as described above. This may also be the 35 case if the body 10′ or similar of the cell phone 10 to which the actuator 30a is attached is made of an electrically conductive material e.g. such as conductive plastic or rubber or similar, or a conductive metal or similar.

Moreover, the electrodes 30aa, 30ab and the electroactive polymer 30ac may e.g., be arranged in a folded manner, e.g. folded as suggested in the patent document WO 2007/029275 (Carpi et al.) mentioned above. Alternatively, the electroactive polymer 30ac and the surrounding electrodes 30aa, 30ab may e.g., be arranged in a helix as is common in connection with actuators made of electroactive polymers.

The electroactive polymer 30ac in the exemplifying actuator 30a is with advantage an ionic electroactive polymer (Ionic EAP), in which actuation is caused by the displacement of ions inside the polymer. Only a few volts are needed for actuation. Examples of ionic EAPs are conductive polymers, ionic polymer-metal composites (IPMCs), and responsive gels. Yet another example is a Bucky gel actuator, which is a polymer-supported layer of polyelectrolyte material consisting of an ionic liquid sandwiched between two electrode layers consisting of a gel of ionic liquid containing single-wall carbon nanotubes. Naturally, other electroactive polymers are conceivable.

FIG. 3c shows the exemplifying actuator 30a in a contracted state. As indicated above, the contraction is preferably caused by applying a voltage across the electroactive polymer 30ac, e.g. by means of the exemplifying electrodes 30aa, 30ab. Since the actuator 30a is attached to the movable arranged touch-surface 22a and to the substantially rigid body 10′ or similar the contraction of the actuator 30a causes the touch-surface 22a to move towards the body 10′ or similar as indicated by the arrow in FIG. 3c. It should be understood that a movement of the touch-surface 22a may include the situation in which only a part of the touch-surface 22a is moved, which e.g. may be the case when a resilient and/or elastic touch-surface 22a is used.

As the observant reader realizes the touch-surface 22a returns to its original position as the actuator 30a resumes its original state as shown in FIG. 3b. As is well known to those skilled in the art, depending on the character of electroactive polymer 30ac the actuator 30a may e.g. resume its original state when the voltage across the polymer 30ac is withdrawn, or when a voltage of opposite potential is applied across the polymer 30ac. If the polymer 30ac does not resume its original state by itself it may be advantageous to apply a second actuator 30a1 on the other side of the touchscreen 20a opposite to the actuator 30a shown in FIG. 3a, which second actuator 30a′ is the same or similar as the first actuator 30a and which second actuator 30a1 is contracted and returned to its original state at opposite intervals compared to the first actuator 30a1 i.e. the second actuator 30a′ is actuated at opposite phase compared to the first actuator 30a.

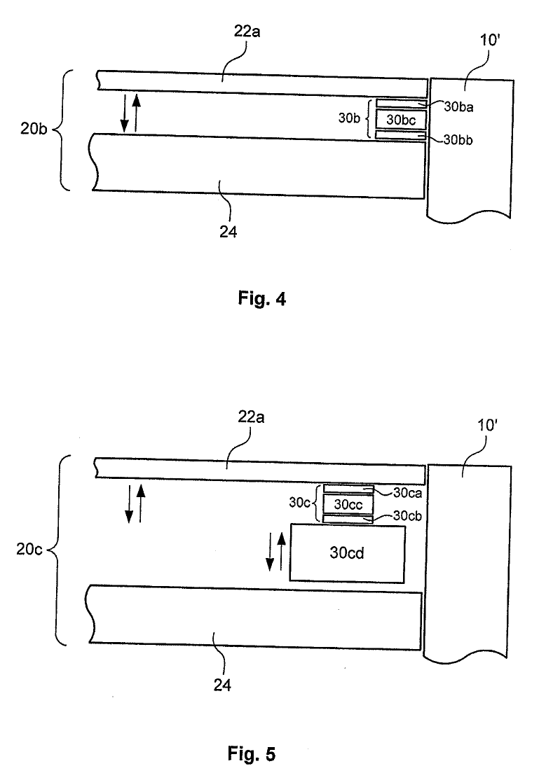

In operation, it is preferred that the electroactive polymer 30ac and hence the actuator 30a is deformed repeatedly so as to repeatedly move the touch-surface 22a back and forth, e.g., in the direction of the extension of the touch-surface 22a as indicated by the two opposite arrows in FIG. 3b. A person skilled in the art realizes that the exemplifying actuator 30a of the tactile touchscreen 20a in FIGS. 3a-3c is preferably designed so that the deformation of the actuator 30a causes movements in the touch-surface 22a that can be perceived by a user of the cell phone 10 touching the touch-surface 22a. The actuator 30a may e.g. cause the touch-surface 22a to vibrate in a manner that can be felt by a user touching the touch-surface 22a. FIG. 4 shows a section of the cell phone 10 and a second exemplifying tactile touchscreen 20b seen in the direction indicated by the arrows A-A in FIG. 3a. The second tactile touchscreen 20b in FIG. 4 comprises, in the same or similar manner as the first tactile touch screen 20a in FIG. 3b, a display function 24 and a touch-surface 22a arranged above the display 24.

However, in contrast to the first exemplifying touchscreen 20a the touchscreen 20b in FIG. 4 comprises another second exemplifying actuator 30b that is attached to the display 24 or to the body 10′ or similar of the cell phone 10 and to the underside surface of the touch-surface 22a facing the display 24. Moreover, it is preferred that the touch-surface 22a is arranged so that it can be actuated by the actuator 30b1 e.g. movably arranged so that it can be moved by the actuator 30b e.g. moved up and down as indicate by the two opposite arrows in FIG. 4.

The second exemplifying actuator 30b is preferably the same or similar as the first exemplifying actuator 30a discussed above. Hence, in the same or similar manner as for the first exemplifying actuator 30a mentioned above it is preferred that the second exemplifying actuator 30b is implemented by means of an electroactive polymer 30bc and a first electrode 30ba and a second electrode 30bb, where the electrodes 30ba1 30bb are preferably arranged on substantially opposite sides of the intermediate region of the electroactive polymer 30bc. However, other mutual arrangements of the electrodes 30aa, 30ab and the electroactive polymer 30ac are conceivable as mentioned above in connection with the description of the first exemplifying actuator 30a. In addition, in the same or similar manner as for the first actuator 30a it is preferred that the electrodes 30ba, 30bb in the second exemplifying actuator 30b are connected or at least controlled by the tactile control 42, and that the tactile control 42 is arranged to operatively apply a voltage to the electrodes 30aa, 30ab as a response to a touch on the touch-surface 22a.

In operation, it is preferred that the electroactive polymer 30bc and hence the second exemplifying actuator 30b is actuated—e.g., repeatedly deformed by being contracted and returned to its original position as described above for the first exemplifying actuator 30a —so as to repeatedly move and/or oscillate the touch-surface 22a up and down, e.g. in a direction substantially orthogonally to the extension of the touch-surface 22a as indicated by the two opposite arrows in FIG. 4. Persons skilled in the art realize that the exemplifying actuator arrangement 30b in the tactile touchscreen 20b is preferably designed so that the deformation of the actuator 30b causes movements in the touch-surface 22a that can be perceived by a user of the cell phone 10 touching the touch-surface 22a. The actuator 30b may e.g., cause the touch-surface 22a to vibrate in a manner that can be felt by a user touching the touch-surface 22a.

As a general remark it should be added that the vibrations or similar movements in the touch-surface as described herein caused by an actuator as described herein may be a wave or similar that propagates in the touch-surface with the effect that there may be stationary nodes in the touch-surface that do not move, e.g. in case a standing wave or similar. Hence, every part of the touch-surface must not necessarily move when the touch-surface is actuated by an actuator as described herein. It follows that some embodiments of the touch-surface or similar may be substantially rigidly attached to the cell phone 10, e.g., at the edges of the touch-surface, whereas the touch-surface itself can move and/or to oscillate under the influence of an actuator as described herein. This may be so in particular when the touch-surface itself is capable of vibrate, e.g. move in the middle whereas the edges of the touch-surface are substantially still, which may occur even if there is no standing wave present.

FIG. 5 shows a section of the cell phone 10 and a third exemplifying tactile touchscreen 20c seen in the direction indicated by the arrows A-A in FIG. 3a. The third tactile touchscreen 20c in FIG. 5 comprises, in the same or similar manner as the first tactile touch screen 20a in FIG. 3b, a display function 24 and a touch-surface 22a arranged above the display 24.

However, in contrast to the first exemplifying touchscreen 20a the touchscreen 20c in FIG. 5 comprises third exemplifying actuator 30c. It is preferred that the third exemplifying actuator 30c is attached to the rear surface being arranged substantially opposite to the front surface of the touch-surface 22a and facing the display 24. In addition, it is preferred that the actuator 30c is attached to a movable body and/or mass 30cd. It is also preferred that the touch-surface 22a is arranged so that it can be actuated by the actuator 30c, e.g., movably arranged so that the body and/or mass 30cd can be moved by the actuator 30c e.g., moved up and down as indicate by the two opposite arrows in FIG. 5. It should be added that the mass and/or body 30cd may be an integral part of the actuator 30c. In some embodiments the mass of the actuator 30c alone may be sufficient to actuate the touch-surface 22a when the actuator 30c is repeatedly deformed as described below.

In the same or similar manner as for the first exemplifying actuator 30a mentioned above it is preferred that the third exemplifying actuator 30c is implemented by means of an electroactive polymer 30cc and a first electrode 30ca and a second electrode 30cb, where the electrodes 30ca, 30cb are preferably arranged on substantially opposite sides of the intermediate region of the electroactive polymer 30cc. However, other arrangements of the electrodes 30ca, 30cb and the electroactive polymer 30cc of the third exemplifying actuator 30c are clearly conceivable, as mentioned above in connection with the description of the first exemplifying actuator 30a.

Moreover, in the same or similar manner as for the first actuator 30a it is preferred that the electrodes 30ca, 30cb in the third exemplifying actuator 30c are connected or at least controlled by the tactile control 42, and that the tactile control 42 is arranged to operatively apply a voltage to the electrodes 30ca, 30cb as a response to a touch on the touch-surface 22a.

In operation, it is preferred that the electroactive polymer 30cc and hence the third exemplifying actuator 30c is actuated—e.g. repeatedly deformed by being contracted and then returned to its original position as described above for the first exemplifying actuator 30a—so as to repeatedly move and/or oscillate the touch-surface 22a up and down, e.g., in a direction substantially orthogonally to the extension of the touch-surface 22a, as indicated by the two opposite arrows in FIG. 5. Persons skilled in the art realize that the exemplifying actuator arrangement 30c of the tactile touchscreen 20c in FIG. 5 is designed so that the deformation of the actuator 30c causes movements in the touch-surface 22a that can be perceived by a user of the cell phone 10 touching the touch-surface 22a. The actuator 30c may e.g. cause the touch-surface 22a to vibrate in a manner that can be felt by a user touching the touch-surface 22a.

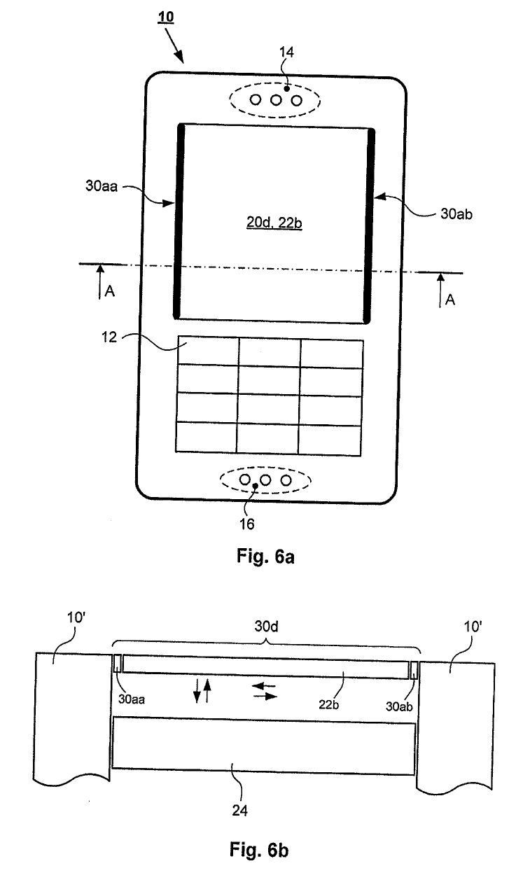

FIG. 6a shows the cell phone in FIG. 1 provided with a second exemplifying tactile touchscreen 20d comprising a display 24 and an exemplifying touch-surface 22b arranged between a first electrode 30aa and a second electrode 30ab. Here it is preferred that the touch-surface 22b or at least an upper layer of the touch-surface 22b is formed of an electroactive polymer, e.g., an electroactive polymer as described in connection with the first exemplifying tactile touchscreen 20a. However, the electrodes 30aa, 30ab are preferably the same as the electrodes 30aa, 30ab though other electrodes are clearly conceivable. As can be seen in FIG. 6a it is preferred that the electrodes 30aa, 30ab are arranged on substantially opposite sides of the touch-surface 22b forming a region of an electroactive polymer or an upper layer of the touch-surface 22b forming a region of an electroactive polymer. However, in the same or similar manner as described in connection with the first exemplifying touch screen 20a there are other positions wherein the electrodes 30aa, 30ab may be arranged to operatively affect the touch surface 22b formed by an electroactive polymer or an upper layer of the touch-surface 22b formed by an electroactive polymer. It is also preferred that the electrodes 30aa, 30ab are connected or at least controlled by the tactile control 42 of the cell phone 10 and that the tactile control 42 is arranged so as to operatively apply a voltage to the electrodes 30aa, 30ab as a response to a touch on the touch-surface 22b. In this manner the touch-surface 22b formed by an electroactive polymer or at least an upper layer of the touch-surface 22b formed by an electroactive polymer can be actuated by applying a voltage across the polymer by means of the electrodes 30aa, 30ab as a response to a touch on the touch-surface 22b, e.g. being repeatedly deformed by being contracted and then returned to its original position as described above for the first exemplifying actuator 30a.

FIG. 6b shows a section of the cell phone 10 and the fourth exemplifying tactile touchscreen 20d seen in the direction indicated by the arrows A-A in FIG. 6a. As can be seen in FIG. 6b the tactile touchscreen 20d comprises a display 24 where the above mentioned touch-surface 22b is arranged above the display 24 so as to substantially cover the display 24. In this respect the touchscreen 20d is similar to the first tactile touch screen 20a as described above with reference to FIG. 3b.

However, as already indicated above the tactile touchscreen 20d has an actuator 30d that differs from the actuator 30a of the previously described touchscreen 20a. As mentioned above it is preferred that the touch-surface 22b or at least an upper layer of the touch-surface 22b is made of an electroactive polymer. It is even more preferred that substantially the entire touch-surface 22b or at least an entire upper layer thereof is made of an electroactive polymer. As can be seen in FIG. 6b the electrodes 30aa, 30ab that are preferably arranged on opposite sides of the intermediate touch-surface 22b or at least an upper layer thereof are preferably attached to the body 10′ or similar of the cell phone 10 or similar. As a person skilled in the art realizes, in this manner it is possible to affect substantially the entire touch surface 22d or an entire upper layer of the touch-surface 22b by applying a suitable voltage to the electrodes 30aa, 30ab. As the observant reader realizes, in this embodiment the actuator arrangement 30d comprises the touch-surface 22b or at least an upper layer of the touch-surface 22b and the electrodes 30aa, 30ab.

In particular, it is preferred that the touch-surface 22b or at least an upper layer of the touch-surface 22b is arranged so that it can be oscillated by the tactile control 42 applying a voltage to the electrodes 30aa, 30ab as a response to a touch on the touch-surface 22a detected by means of the tactile control 42 comprising such hardware and software that is well known to those skilled in the art as being suitable for detecting a touch on the touch-surface 22a as previously discussed. The oscillation caused by a voltage applied over the electrodes 30aa, 30ab is preferably generating a wave or similar that propagates in the touch-surface 22b. This implies that the touch-surface 22a or an upper layer of the touch-surface 22b can be substantially rigidly attached, e.g. rigidly attached to the cell phone 10 at the edges of the touch-surface 22a, whereas the touch-surface 22a itself moves and/or oscillates or similar. The movement and/or oscillation or similar of the touch-surface 22a may occur in the horizontal as well as in the vertical direction as indicated by the two pairs of opposite arrows in FIG. 6b. This is generally so in case a wave or similar propagates in the touch-surface as described in connection with the embodiment herein.

A person skilled in the art realizes that the exemplifying actuator arrangement 30d of the second exemplifying tactile touchscreen 20d in FIGS. 6a-6b is designed so that the deformation of the touch-surface 22b causes movements that can be perceived by a user of the cell phone 10 touching the touch-surface 22b. The deformation may e.g. cause the touch-surface 22b to oscillate in a manner that can be felt by a user touching the touch-surface 22b.

In an alternative embodiment the oscillation caused by a voltage applied over the electrodes 30aa, 30ab and the touch-surface 22b or an upper layer of the touch-surface 22b in FIGS. 6a-6b is preferably generating a sound wave or similar that propagates in the air surrounding the touch-surface 22b. This can e.g. be utilized to propagate speech and 10 other sounds from the cell phone 10 into the air. In this manner the loudspeaker 13 of the cell phone 10 may be replaced or supplemented by the sound generating touch-surface 22b of the tactile touchscreen 20d. The same or similar applies mutatis mutandis to the touch surface 22a of the touchscreens 20a-20c described above, which by suitable selections of the properties of the actuator 30a and the touch-surface 22a can be made to vibrate and/or oscillate so as to generate audible sounds perceivable to a user of the cell phone 10.

As explained above, a cell phone 10 according to an embodiment of the present invention comprises a touchscreen provided with a touch-surface arranged to be actuated, and an actuator of an electroactive polymer arranged to operatively actuate the touch-surface. In particular, as will be explained in more detail below, the actuator is arranged to be operatively actuated by the tactile control 42 as a response to a touch on the touch-surface detected by the tactile control 42 comprising such hardware and software that is well known to those skilled in the art as being suitable for detecting a touch on the touch-surface.

Advantageous embodiments of the present invention use an actuator comprising a electroactive polymer arrangement, which provides a shockproof and highly flexible actuator with high compliance, low density, low power consumption, simple manufacturing and low cost.

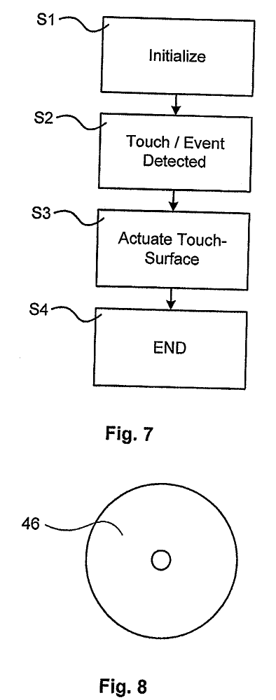

The attention is now directed to the steps in an exemplifying method for providing a tactile response to a touch on the touch-surface detected by the tactile control 42, which exemplifying steps will be described with reference to the exemplifying flowchart in FIG. 7. The steps of the method are preferably implemented by means of the feedback-control 42 as schematically illustrated in FIG. 2.

In a first step S1 of an exemplifying method according to an embodiment of the present invention the tactile function preformed by the feedback-control 42 is initialized. The initialization may include such actions as activating the touch sensing function comprised by the feedback-control 42, e.g. activating a resistive, capacitive, surface-wave-acoustic (SAW) or infrared touch sensing arrangement or some other suitable touch sensing technique that is comprised by the feedback-control 42 and that is arranged so as to detect touches on the touch-surface 22a, 22b of the cell phone 10 as described above and as is well known to those skilled in the art. The initialization may also include such actions as initializing the tactile function connected to and/or controlled by the feedback control 42 as described above.

In a second step S2 of the exemplifying method it is preferred that a touch on the touch-surface 22a or 22b is detected by means of the touch sensing technique that is preferably comprised by the feedback-control 42 and that is arranged so as to detect touches on the touch-surface 22a or 22b. As an alternative, in some embodiment the feedback-control 42 is arranged to operatively detect an event, e.g. by receiving a notification from the control unit 40 when an event has occurred. The event may e.g. be the occurrence of an alarm or a message that is detected by the feedback control 42 or similar of the cell phone 10. The message may e.g. be a SMS (Short-Message-Service) or similar or an incoming phone call or similar. The message may even be a voice or music signal or another alarm or sound signal or similar that is to be presented to the user. Indeed, the event may be substantially any event that can be tactilely and/or audible presented to the user of the cell phone 10 or similar portable device.

In a third step S3 of the exemplifying method it is preferred that the actuator 30a1 30b, 30c or 30d is activated so as to provide a tactile feedback to be felt by the user as a response to the touch detected on the touch-surface 22a or 22b. As mentioned above, the tactile feedback may be an oscillation, a vibration, a wave or similar that may propagate in the touch-surface 22a or 22b and that can be felt by a user of the cell phone 10. Indeed, as also indicated above, the feedback may even be a sound or similar that propagates from the touch-surface 22a or 22b in the air so that it can be heard by the user of the cell phone 10 or similar device, e.g. an alarm signal, a ring signal or some other signal or even voice or music signals or similar.

In a fourth step S4 of the exemplifying method it is preferred that the tactile function preformed by the feedback-control 42 is terminated and that the oscillation, vibration or wave or similar of the touch-surface 22a or 22b is terminated. The termination may e.g., occur when the detection of a touch ends or after the lapse of a predetermined time, e.g., after less than one or a few tents of a second or after less than one or a few seconds or similar. Alternatively the termination may occur after the termination of an event, e.g., after 10 the termination of a ring signal, an alarm signal or a voice message or similar.

In general, as previously explained, it is preferred that the feedback-control 42, arranged to perform the exemplifying method described above, is provided in the form of one or more processors with corresponding memory containing the appropriate software in the form of a program code. However, the program code can also be provided on a data carrier such as a CD ROM disc 46 as depicted in FIG. 8 or an insertable memory stick, which will perform the invention when loaded into a computer or into a phone having suitable processing capabilities. The program code can also be downloaded remotely from a server either outside or inside the cellular network or be downloaded via a computer like a PC to which the phone is temporarily connected.

The present invention has now been described with reference to exemplifying embodiments. However, the invention is not limited to the embodiments described herein. On the contrary, the full extent of the invention is only determined by the scope of the appended claims.

What is claimed is:

1. A device including a touch sensitive arrangement, comprising;
a touch-surface configured to be operatively actuated and to operatively receive a touch from a user of the device;
an actuator arrangement configured to operatively actuate at least a portion of the touch-surface,
a control arrangement configured to operatively detect the touch via the touch-surface and to operatively control the actuator, wherein:
the actuator arrangement includes an electroactive polymer arrangement configured to be operatively actuated by the control arrangement to actuate the touch-surface to provide a perceivable feedback to the user in response to the detected touch.

2. The device of claim 1, wherein said electroactive polymer arrangement comprises:
at least one region of an electroactive polymer, at least a first electrode arrangement, and at least a second electrode arrangement which are configured to operatively actuate the at least one region of the electroactive polymer and to be operatively controlled by said control arrangement.

3. The device of claim 1, wherein the actuator arrangement is attached to said touch-surface for operatively actuating the touch surface to provide the perceivable feedback to the user.

4. The device of claim 3, wherein the actuator arrangement is attached to a rear surface of the touch-surface or to a side of the touch-surface.

5. The device of claim 1, wherein the electroactive polymer arrangement comprises at least one region of an electroactive polymer that is formed by the touch-surface.

6. The device of claim 5, wherein substantially the touch-surface is substantially entirely formed from an electroactive polymer.

7. The device of claim 1, wherein:
the actuator arrangement and the touch-surface and said control arrangement are configured to operatively provide at least one of a tactile feedback or an audible feedback to the user in response to an event detected by the control arrangement.

8. The device of claim 7, wherein the audible feedback comprises at least one of a voice signal or a music signal in response to the detected event.

9. In a device including a touch sensitive arrangement, a method comprising:
receiving a touch from a user of the device via a touch-surface, wherein at least a portion of the touch-surface is configured to be actuated by an actuator arrangement;
detecting, by a control arrangement, the touch on the touch-surface;
controlling, by the control arrangement, the actuator to actuate the touch-surface; and
providing a perceivable feedback to the user in response to the detected touch, wherein the actuator arrangement includes an electroactive polymer arrangement configured to be operatively actuated by the control arrangement to actuate the touch-surface to provide perceivable feedback to the user in response to the detected touch.

10. The method of claim 9, wherein the electroactive polymer arrangement comprises:
at least one region of an electroactive polymer,
at least a first electrode arrangement, and
at least a second electrode arrangement which are arranged to operatively actuate the at least one region of the electroactive polymer and to be operatively controlled by the control arrangement, the method further comprising:
actuating the first electrode arrangement and the second electrode arrangement of the region to provide the perceivable feedback.

11. The method of claim 9, wherein the electroactive polymer arrangement comprises:
at least one region of an electroactive polymer that is formed by the touch-surface, the method further comprising:
actuating the at least one region to provide the perceivable feedback.

12. The method of claim 11, wherein substantially an entire area of the touch-surface is formed by the electroactive polymer.

13. The method of claim 9, further comprising:
actuating the actuator arrangement and the touch-surface to operatively provide at least one of a tactile feedback or an audible feedback to the user in response to an event detected by the control arrangement.

14. The method according of claim 9, further comprising:
actuating the actuator arrangement and the touch-surface to provide at least one of a voice signal or a music signal to the user in response to the detected event.

15. A computer-readable storage device executable in a portable device, the computer-readable storage device comprising:
instructions to:
receive a touch from a user of the device via a touch-surface, wherein at least a portion of the touch-surface is configured to be actuated by an actuator arrangement;
detect, by a control arrangement, the touch on the touch-surface;
control, by the control arrangement, the actuator to actuate the touch-surface; and
provide a perceivable feedback to the user in response to the detected touch, wherein the actuator arrangement includes an electroactive polymer arrangement configured to be operatively actuated by the control arrangement to actuate the touch-surface to provide perceivable feedback to the user in response to the detected touch.

16. A computer program element having a program recorded thereon, where the program is to make a portable device to execute, when said program is loaded in the portable device, comprising:
a touch-surface arranged to be operatively actuated and to operatively receive touches from a user of the device;
an actuator arrangement arranged to operatively actuate at least a part of said touch-surface;
a control arrangement arranged to operatively detect a touch on said touch-surface and to operatively control the actuator to actuate said touch-surface so as to provide a perceivable feedback to the user as a response to a detected touch, wherein
said actuator arrangement comprises an electroactive polymer arrangement arranged to be operatively actuated by said control arrangement so as to actuate said touch-surface for providing a perceivable feedback to the user as a response to a detected touch, the steps of:
detecting a touch on the touch-surface,
actuating the electroactive polymer arrangement comprised by the actuator arrangement so as to provide a perceivable feedback from the touch-surface to the user as a response to a detected touch.
